(19) United States
(12) Patent Application Publication
(10) Pub. No.: US 2005/0110314 A1
(43) Pub. Date: May 26, 2005

(54) Element protection cycle seat cover

(76) Inventor: Theodore William Buselmeier, St. Paul, MN (US)

Correspondence Address: Theodore William Buselmeier, 579 Bidwell Ave., St. Paul, MN, 55107, US

(21) Appl. No.: 10/964,470

(22) Filed: Oct. 13, 2004

Related U.S. Application Data
(60) Provisional application No. 60/511,944, filed on Oct. 15, 2003.

(51) Int. Cl. B60J 1/00

(52) U.S. Cl. 297/219.11

(57) ABSTRACT

A cycle (bicycle, motorcycle, etc) seat cover to protect the seat or seat cover's sitting surface from the elements (precipitation, heat, etc.). A cycle saddle cover includes a reflective, impermeable fabric/film enwrapment having a top, bottom, and a perimeter with the perimeter being in the general shape of a cycle saddle. The cover fits over the cycle seat and has an elastic ring-shaped band, Velcro, or a tie cord disposed in the enwrapment body is provided for its cinching the cover around the bicycle seat. It is attached to the cycle frame by a strap (Velcro, elastic, etc.) when not in use.

### BACKGROUND OF THE INVENTION

This invention relates generally to modem conventional bicycle (or other cycle) saddle covers. Current bicycle seat covers are designed to supplement a bicycle seat, adding padding and comfort to the design.

Some of the known related prior art includes the following U.S. Pat. No. 6,019,425 entitled “BICYCLE SADDLE COVER”, U.S. Pat. No. 4,319,781 entitled “BICYCLE SEAT COVER”. These seat covers use pads or gel inserts to provide a padded surface to provide comfort or reduce friction for the cyclist to sit on. However, these covers do not protect the sitting surface from the elements. No prior art was found specifically to protect the seat from the elements.

The present invention provides for a seat cover that protects the seat or seat cover from the elements. This allows the cyclist to cover his seat while not in use, providing a dry, temperate, surface to sit on.

This invention is a further description of the invention described in my provisional application No. 60/511,944, conf. no 6421 and it is my intent to preserve my filing date of 10-15-2003.

### SUMMARY OF THE INVENTION

The present invention is for any cycle, motorized or other; non-limiting examples include bicycles, unicycles, tryicycles, motorcycles, all terrain vehicles, etc. It provides a novel and unobvious way to protect a cyclist's buttocks from the elements the seat is exposed to during nonuse. It is novel and unobvious in its purpose.

The cover is removable. It is to be applied when the seat is not in use and to be removed when the cyclist rides.

This cover is reusable. It is attached temporarily to the seat by Velcro, drawstring, or other device so as to stay in place while the cyclist is not present. It is attached to the cycle frame when the cyclist rides so that she may reuse it when needed to protect her sitting surface.

It is insulated and is made of impermeable, reflective material so as to protect the seat from precipitation and extreme temperatures. Non-limiting examples of material include synthetics, nylon, polyurethane, plastics, or any other material appropriate to obtain the desired function explained above.

### DESCRIPTION OF DRAWINGS

FIG. 1 is a top plan view of a first embodiment of the invention;

FIG. 2 is a cross-sectional view taken along the plane indicated by 2-2 in FIG. 1;

FIG. 3 is a bottom plan view of an embodiment of the invention having a strap 18 incorporated therein for holding the cover in a folded configuration; and

FIG. 4 is a bottom plan view of an embodiment of the invention shown in its folded configuration, attached securely to the frame or body of a cycle by the strap 18.

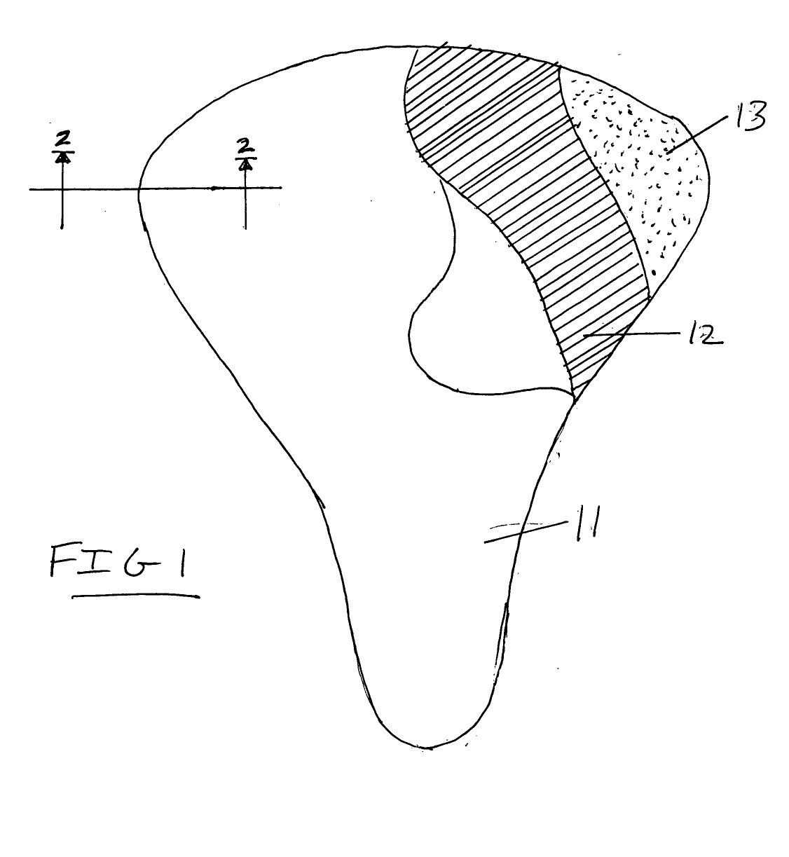

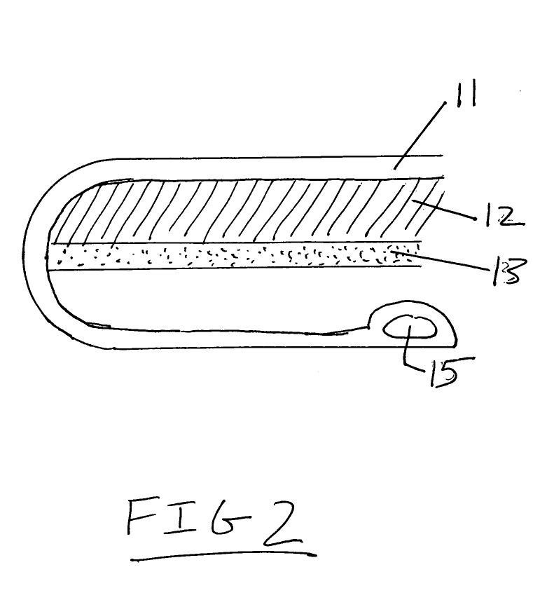

Referring now to FIGS. 1 and 2, an embodiment of the invention is illustrated. The cover of the invention has an outer layer portion 11 which is fabricated of an impermeable, reflective material such as Mylar or Nylon. This outer layer completely surrounds an inner layer 12 of an insulating material such as Thinsulate. The bottom layer 13 is fabricated of a breathable layer such as Gore-text or cotton. The outer layer 11 reflects and provides a barrier for the elements, the middle layer 12 provides insulation, keeping the seat temperature stable, the bottom layer 13 keeps the seat dry by providing a breathable barrier that prevents condensation.

It should be noted that the invention may also be used with one layer, or multiple layers fabricated of the same or similar or different materials or a combination thereof.

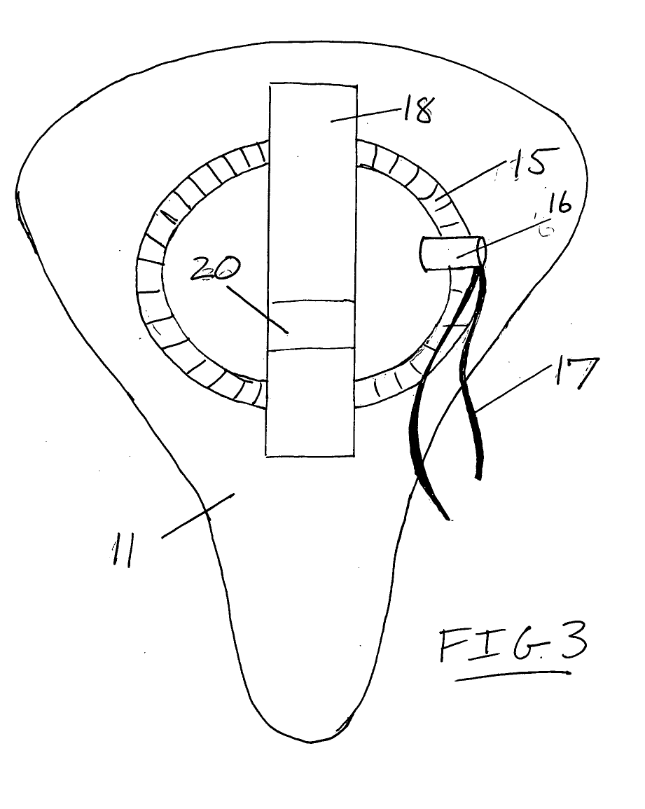

As can be seen in FIG. 3, the elastic band 15 and/or drawstring 17 with/without toggle 16 retains the cover in position on the seat.

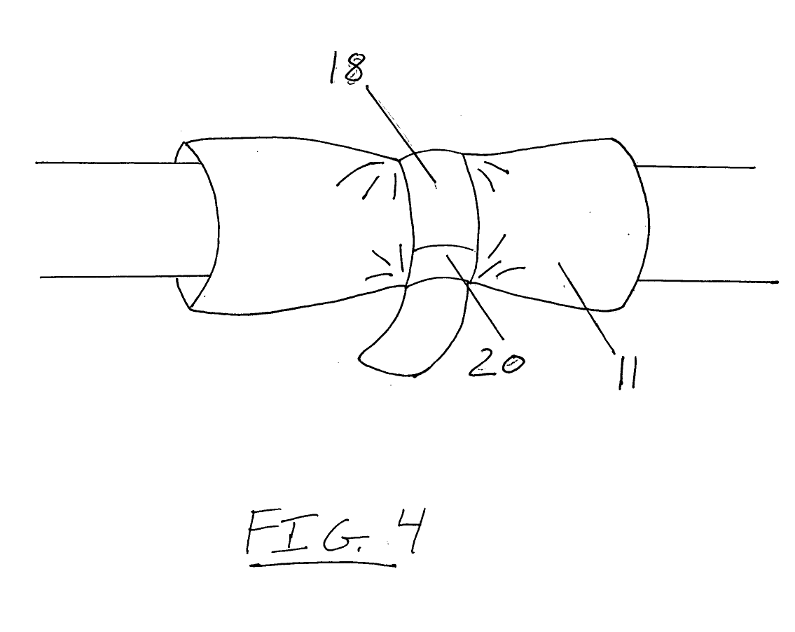

Referring now to FIGS. 3 and 4, a preferred embodiment of the invention is shown. This embodiment may be similar to the first embodiment illustrated but incorporates a strap 18 which may be of elastic, Velcro, or snap for retaining the cover in its folded condition. As shown in FIG. 4 the strap 18 can be wound around the folded cover and around the frame or body of the cycle securing it while the cyclist travels. The Velcro or snap connector 20 is used to hold the cover in its folded condition for carrying on the cycle, in one's pocket, or for storage.

While the invention has been described and illustrated in detail, it is clearly to be understood that this is intended by way of illustration and example only, and is not to be taken by way of limiting the spirit and scope of this invention.

1. A cycle seat cover comprising:
A reflective, impermeable fabric/film enwrapment having a top, bottom, and layer and a perimeter with the perimeter being in the general shape of a cycle seat to protect the seat or seat cover from the elements;
means, attached to or disposed in the enwrapment bottom, for cinching the cover around a cycle seat, the means for cinching comprising an elastic ring-shaped band, Velcro, or a tie cord; and
means to attach the cover to the cycle frame by a strap comprised of Velcro, elastic, toggle, snap, or tie.

2. The cycle seat cover according to claim 1 wherein the enwrapment top and bottom comprise different fabric/film materials.

3. The cycle seat cover according to claim 1 wherein the enwrapment top and bottom comprise same fabric/film materials.

4. The cycle seat cover according to claim 1 with only one layer.

5. The cycle seat cover according to claim 1 with multiple layers;
with middle layer(s) comprising of different material as top and bottom; or
with middle layer(s) comprising of same material as top and bottom.
